(19) United States
(12) Patent Application Publication
(10) Pub. No.: US 2015/0220934 A1
(43) Pub. Date: Aug. 6, 2015

(54) METHODS AND APPARATUS FOR REGISTERING PRODUCTS WITH MANUFACTURERS AT POINT OF SALE

(71) Applicant: MasterCard International Incorporated, Purchase, NY (US)

(72) Inventor: Rohit Chauhan, Somers, NY (US)

(73) Assignee: MasterCard International Incorporated, Purchase, NY (US)

(21) Appl. No.: 14/172,311

(22) Filed: Feb. 4, 2014

(51) Int. Cl. G06Q 30/00; G06Q 20/20

(52) U.S. Cl. CPC G06Q 30/012; G06Q 20/20; G06Q 20/204

(57) ABSTRACT

A method includes reading purchased-item information by a point-of-sale (POS) device from a purchased item presented to the POS device. The method further includes determining by the POS device that the purchased item is eligible for warranty registration, and reading a payment card by the POS device. The method also includes querying a customer by the POS device as to whether the customer wishes to trigger warranty registration for the purchased item, and receiving by the POS device an indication from the customer to trigger warranty registration for the purchased item. In addition, the method includes sending by the POS device a message to a customer profile server to trigger warranty registration of the purchased item.

### BACKGROUND

Manufacturers of many products, such as electronic devices, electrical appliances, motorized outdoor equipment, etc., customarily request their customers to engage in a registration process following purchase of the product. The registration process serves to link, for the manufacturer's records, a particular customer with a particular device or item of equipment. Often this request is connected with the manufacturer's warranty policies with respect to the product and thus may be referred to as “warranty registration” for the product. For the manufacturer, the product warranty registration provides advantages such aiding in dissemination of product upgrades, safety warnings, product recalls, follow-up sales activities, and so forth.

According to conventional practices, the customer is requested to fill out and return a postcard to the manufacturer, or to visit the manufacturer's website to fill in a warranty registration form for the product. However, many customers find these activities to be tedious and inconvenient and therefore do not comply with the requested warranty registration process.

U.S. Pat. No. 7,712,661 issued to Theodosius Thomas attempts to address the shortcomings of conventional warranty registration practices. According to the Thomas patent, information about a customer is associated with a transaction code at the point of sale. The transaction code is provided to the customer, who subsequently enters the code into the purchased item. The item has computing and communication capabilities and uses such capabilities to transmit the transaction code and information about itself to a registration server. The registration server then uses the transaction code to retrieve customer information from the point of sale.

Thomas's warranty registration scheme partially automates the warranty registration process, but nevertheless suffers from disadvantages and limitations. For example, even with Thomas's approach, the customer is required to receive and retain the transaction number until he or she enters it into the purchased device. The latter activity may require the customer to use/navigate the device's user interface, which may or may not be simple and user-friendly. The customer may in fact find these requirements to be inconvenient, and thus there is no assurance of a high rate of customer compliance with Thomas's proposed process.

Moreover, Thomas' process can be implemented only with products that have the necessary information processing and remote communication capabilities. Accordingly, there are entire classes of products to which Thomas's process cannot practically be applied.

There is accordingly a need for a warranty registration process that from the customer point of view is simple, seamless, streamlined and requires virtually no effort to achieve compliance.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a system provided in accordance with aspects of the present disclosure.

FIG. 2 is a block diagram representation of a server computer that aids in administration of a warranty registration process in accordance with aspects of the present disclosure and is depicted as part of the system of FIG. 1.

FIG. 3 is a block diagram representation of a typical POS device that may embody aspects of the present disclosure.

FIG. 4 is a flow chart that illustrates aspects of the present disclosure, including a portion of the operations of the server computer of FIG. 2.

FIG. 5 is a flow chart that illustrates aspects of the present disclosure, including a portion of the operations of the POS device of FIG. 3.

FIG. 6 is a flow chart that illustrates aspects of the present disclosure, including an additional portion of the operations of the server computer of FIG. 2.

FIG. 7 is a block diagram representation of further features that may be included in the system of FIG. 1 according to some aspects of the disclosure.

FIG. 8 is a flow chart that illustrates aspects of the present disclosure, including a portion of operations of an e-commerce server shown in FIG. 7.

FIG. 9 is a flow chart that illustrates an alternative manner of operation for the e-commerce server according to aspects of the disclosure.

FIG. 10 is a flow chart that illustrates a portion of the operations, in accordance with aspects of the disclosure, of a warehouse terminal device shown in FIG. 7.

FIG. 11 is a flow chart that illustrates a process that may be performed by the server of FIG. 2 in accordance with other aspects of the disclosure.

### DETAILED DESCRIPTION

In general, and for the purpose of introducing concepts of embodiments of the present disclosure, warranty registration records are created and stored for individuals who have been issued credit or debit cards or other payment cards. The records contain the names and contact information for the individuals. When a product item is presented for purchase at a point-of-sale (POS) device, with payment by payment card, the POS device reads product information from the purchased item, determines whether it is eligible for warranty registration, and if so the customer is queried as to whether he/she wishes to have the registration take place. If the customer indicates a positive response to the query, the POS device then forwards the customer's payment card account number (read from the customer's payment card) and details about the purchased item to a central warranty registration server computer. The server retrieves the customer's warranty registration record, and uses the information contained therein, with the product information supplied by the POS device, to complete the warranty registration process. Thus, the server links the customer, including his/her contact information, with the required product information for registration purposes all in response to a simple go-ahead indication given by the customer at point of sale. The effort required on the customer's part is minimal and compliance can be expected to be high. Also, this approach does not require the purchased item to have any computing or communications capabilities.

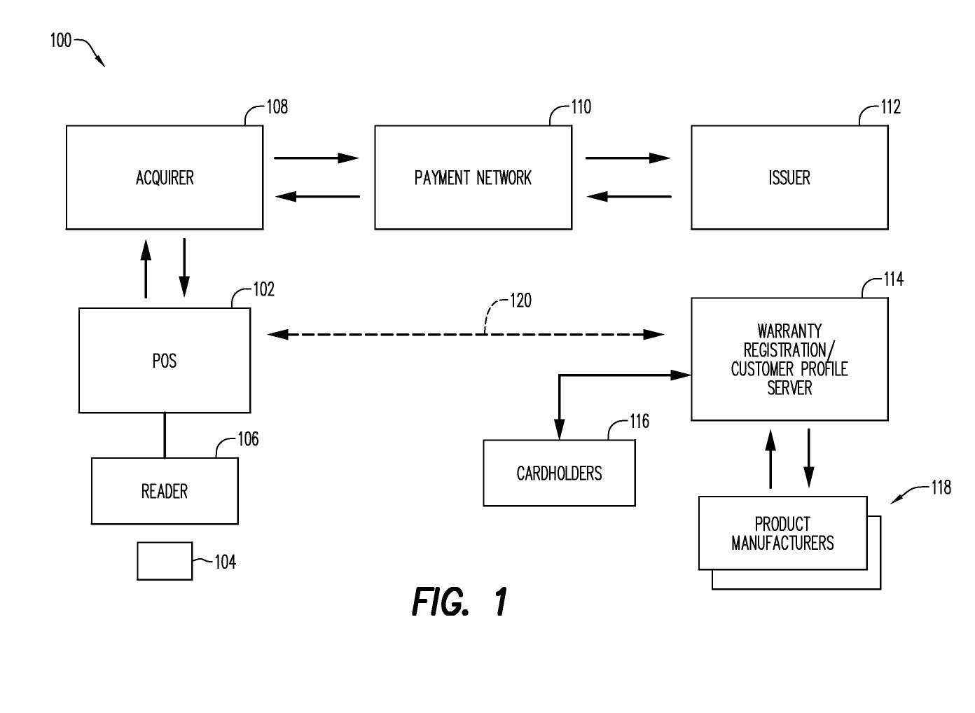

FIG. 1 is a block diagram that illustrates a system 100 provided in accordance with aspects of the present disclosure.

In many respects the system 100 incorporates features of a conventional card-based payment system. For example, at the point of sale a POS device 102 is present. A payment card 104 is shown being presented to a reader component 106 associated with the POS device 102. (For at least some purposes, the reader component 106 may be considered part of the POS device 102.) In some embodiments the payment card 104 may be entirely conventional, and may be for example a magnetic stripe card. In addition or alternatively, the payment card 104 may include an integrated circuit chip (not separately shown) suitable for having data read from it by proximity RF (radio frequency) communications. The primary account number (PAN) for the payment card account represented by the payment card 104 may be stored on the magnetic stripe (not separately shown) and/or the IC chip (if present) for reading by the reader component 106 of the POS device 102.

From the foregoing, it will be appreciated that the reader component 106 may also be conventional, and may be configured to perform either or both of magnetic stripe reading and reading of IC chips by proximity RF communications. Thus, the payment card 104 may be swiped through a mag stripe reading portion (not separately shown) of the reader component 106, or may be tapped on a suitable surface of the reader component 106 to allow for proximity reading of its IC chip.

It should be understood that instead of a card-shaped payment device, such as the payment card 104, a suitable conventional payment-enabled mobile phone, electronic wallet, or a payment fob may be presented to and read by the reader component 106. Thus, as used herein and in the appended claims, the term “payment card” should be understood to include payment-enabled mobile phones, payment fobs, electronic wallet, or any other device from which a PAN and associated information may be submitted to the POS device 102.

The POS device 102 and the reader component 106 may be entirely conventional in their hardware aspects, and may also include conventional software to supply the usual functionality for such devices. In addition, the POS device 102 may be programmed in accordance with aspects of the present disclosure to provide functionality as described below. The POS device 102 may be located at a retail store location (not separately indicated) and may be operated by or on behalf of a merchant.

As is familiar to users of payment cards, the POS device 102 and/or the reader component 106 may include one or more display screens (not separately shown) for communicating information to the user and/or the sales associate who operates the POS device. (It is also contemplated that the POS device 102 may be of the self-service type, such that it is operated entirely by the customer, and no sales associate is present.) In some embodiments, one or more display screens may comprise a touch screen and so may be an information input component as well as an information output component for the POS device 102.

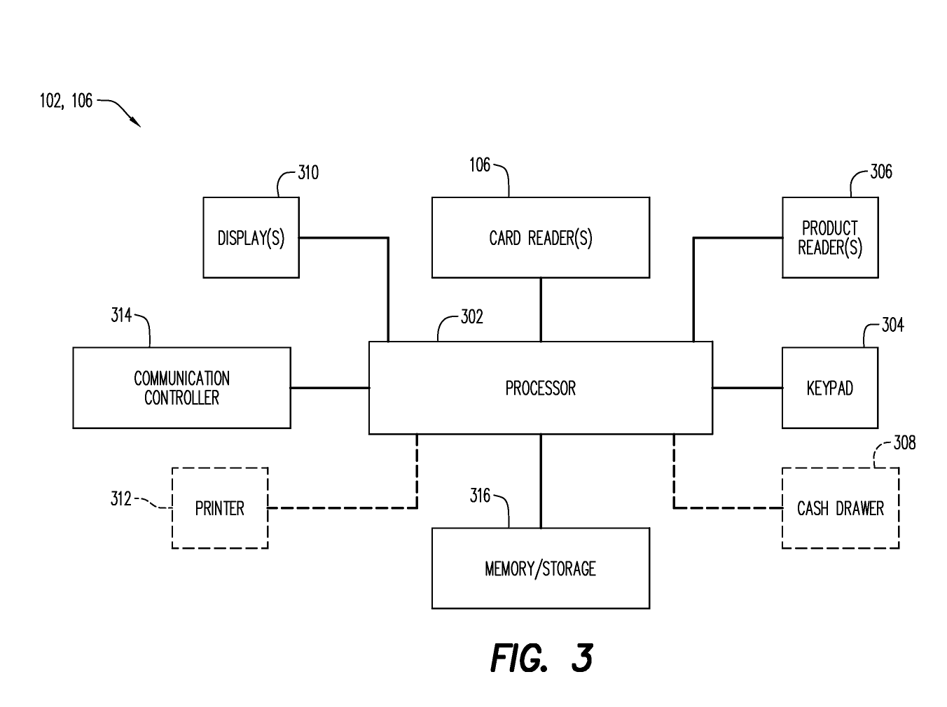

As is increasingly the case, the POS device 102 may in some embodiments be implemented as a suitably programmed smart phone or tablet computer having a small mag stripe reading accessory attached thereto. Further details of some embodiments of the POS device 102 will be described below in conjunction with FIG. 3.

A computer 108 operated by an acquirer (acquiring financial institution) is also shown as part of the system 100 in FIG. 1. The acquirer computer 108 may operate in a conventional manner to receive an authorization request for the transaction from the POS device 102. The acquirer computer 108 may route the authorization request via a payment network 110 to the server computer 112 operated by the issuer of the payment card account that is available for access by the payment card 104. Also in a conventional manner, the authorization response generated by the payment card issuer server computer 112 may be routed back to the POS device 102 via the payment network 110 and the acquirer computer 108.

The payment network 110 may be entirely or substantially conventional; one example of a suitable payment network is the well-known Banknet® system operated by MasterCard International Incorporated, which is the assignee hereof.

The components of the system 100 as depicted in FIG. 1 are only those that are needed for processing a single transaction. Those who are skilled in the art will recognize that a practical embodiment of the system 100 may process many purchase transactions (including simultaneous transactions) and may include a considerable number of payment card issuers and their computers, a considerable number of acquirers and their computers, and numerous merchants and their POS devices and associated reader components. The system may also include a very large number of payment card account holders, who carry payment cards and/or other payment-enabled devices.

FIG. 1 also shows other aspects of the system 100, the latter aspects being provided in accordance with aspects of the disclosure to support a highly automated warranty registration process. Thus, the system 100 includes a server computer 114 that performs warranty registration functions and also is a data repository for customer profiles that facilitate automated product warranty registration. For the sake of simplicity, the server computer 114 will hereinafter be referred to as the “customer profile server computer.” As part of its functionality, the customer profile server computer 114 may enroll and/or interact directly or indirectly with individuals (represented at 116 in FIG. 1) who hold payment card accounts issued under the auspices of the payment network 110. As will be seen, the customer profile server computer 114 also may interact with product manufacturers, represented at 118 in FIG. 1. (As used herein and in the appended claims, the term “product manufacturer” should be understood to include distributors of products as well as manufacturers thereof.)

In some embodiments, the customer profile server computer 114 may be operated by or on behalf of the organization that operates the payment network 110. In some embodiments, for example, the customer profile server computer 114 may be co-located with, or share hardware aspects with, processing components of the payment network 110.

As will be discussed below, the customer profile server computer 114 may be in communication at appropriate times with the POS device 102, via a communication channel indicated at 120. The communication channel 120 is indicated in dashed-line fashion to suggest that it is or may be separate from the communication channels employed in a conventional payment card authorization transaction.

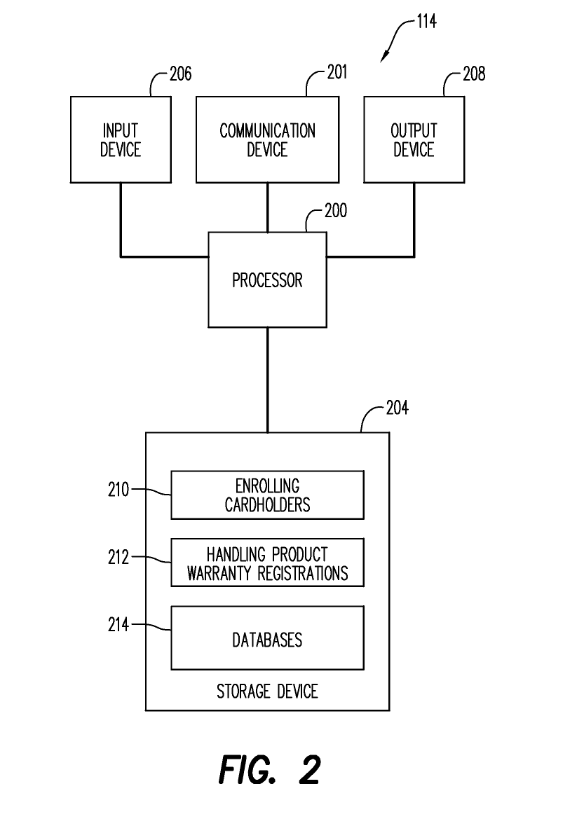

FIG. 2 is a block diagram that illustrates an embodiment of the customer profile server computer 114 (FIG. 1).

The customer profile server computer 114 may be conventional in its hardware aspects but may be controlled by software to cause it to function as described herein. For example, the customer profile server computer 114 may be constituted by conventional server computer hardware.

The customer profile server computer 114 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the customer profile server computer 114 to provide desired functionality.

Communication device 201 may be used to facilitate communication with, for example, other devices (such as one or more devices operated at the point of sale, such as the POS device 102 shown in FIG. 1 and described further below; one or more e-commerce server computers, as discussed below; computers, smart phones and the like operated by individual cardholders (reference numeral 116 in FIG. 1); and/or computers operated by one or more product manufacturers (reference numeral 118 in FIG. 1)). For example (and continuing to refer to FIG. 2), communication device 201 may comprise numerous communication ports (not separately shown), to allow the customer profile server computer 114 to communicate simultaneously with a number of other computers and other devices, including communications as required to simultaneously handle numerous requests for cardholder enrollments and/or product warranty registrations.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the customer profile server computer 114, executed by the processor 200 to cause the customer profile server computer 114 to function as described herein.

The programs may include one or more conventional operating systems (not shown) that control the processor 200 so as to manage and coordinate activities and sharing of resources in the customer profile server computer 114, and to serve as a host for application programs (described below) that run on the customer profile server computer 114.

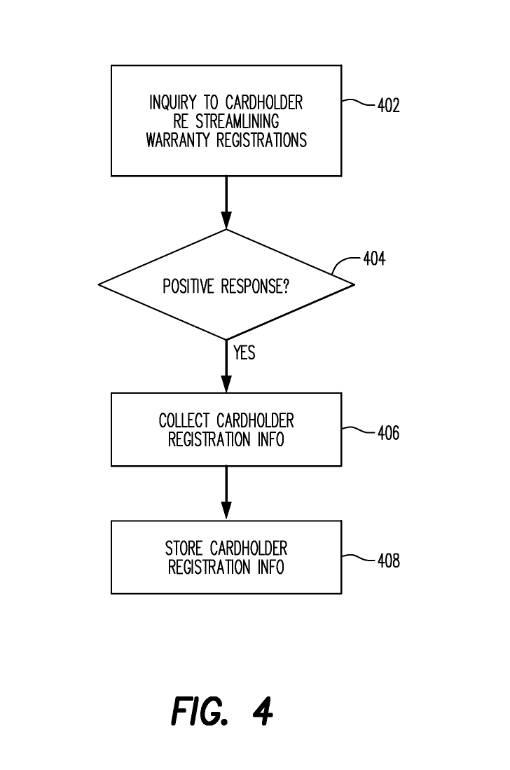

The programs stored in the storage device 204 may also include a cardholder enrollment application program 210 that controls the processor 200 to enable the customer profile server computer 114 to generate and store customer profiles for cardholders who hold payment card accounts serviced by the payment network 110. Details of the functionality provided by the cardholder enrollment application program will be discussed below in conjunction with FIG. 4.

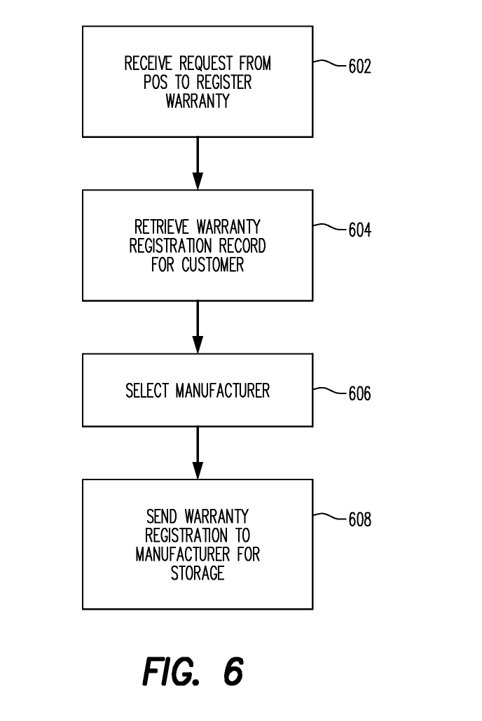

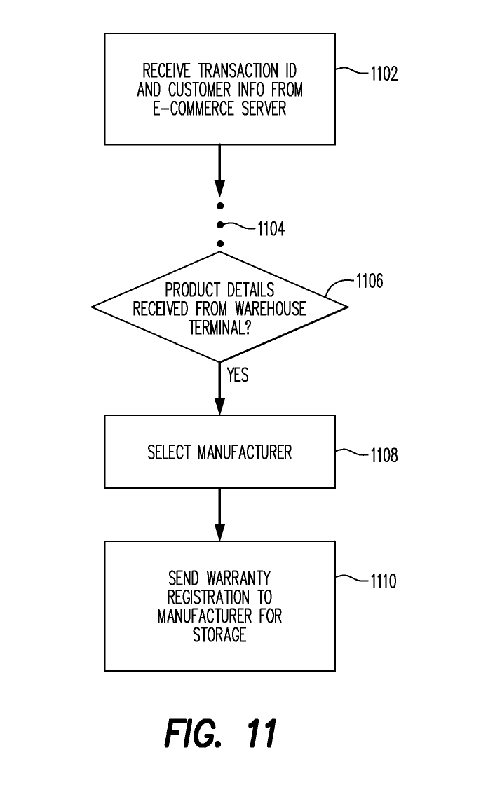

Another program that may be stored in the storage device 204 is an application program 212 that controls the processor 200 to enable the customer profile server computer 114 to handle requests for product warranty registrations received from devices operated at the point of sale by merchants. Details of various features and/or embodiments of the warranty registration request handling application program 212 will be described below in conjunction with FIGS. 6 and 11.

The storage device 204 may also store, and the customer profile server computer 114 may also execute, other programs, which are not shown. For example, such programs may include a reporting application, which may respond to requests from system administrators for reports on the activities performed by the customer profile server computer 114. The other programs may also include, e.g., device drivers, etc.

The storage device 204 may also store one or more databases 214 required for operation of the customer profile server computer 114. Such databases may include, for example, a database (not separately indicated) for storing the customer profiles of the cardholders who have enrolled for the streamlined warranty registration process provided by the system 100, and/or a database (not separately indicated) of product manufacturers whose products are serviced by the warranty registration process provided by the system 100.

FIG. 3 is a block diagram of a typical embodiment of the POS device 102 depicted in FIG. 1 (and incorporating the reader component 106—also shown in FIG. 3). In some embodiments, the POS device 102 may be largely or entirely conventional in its hardware aspects. Nevertheless, the POS device 102 may be programmed in accordance with aspects of the present disclosure to provide functionality as described herein.

The POS device 102 may include a processing element (or elements) such as the processor 302 shown in FIG. 3. The processor 302 may, for example, be a conventional microprocessor, and may operate to control the overall functioning of the POS device 102. In other embodiments, such as when the POS device 102 is constituted primarily by a smartphone, the processor 302 may be one or more processing elements of conventional smart phone integrated circuit components.

The POS device 102 may also include conventional peripheral components, in communication with and/or controlled by the processor 302, such as: (a) a keypad 304 for receiving input from the human operator of the POS terminal; (b) a product reader 306 for reading any form of unique product identifier, such as a barcode or RFID, that appears on, or is attached to, products brought to the terminal for purchase; (c) a cash drawer 308 for storing cash received from customers; (d) the card reader(s) 106, which, as noted above may include a mag stripe reader, and/or a contactless IC chip reader, or additionally or alternatively, a contact IC chip reader, a proximity reader for reading payment card information from a payment-enabled smart phone, a fob reader, and/or other device for reading payment card information; (e) one or more displays 310 for providing output (e.g., identifying products presented for purchase and their prices, indicating sales tax due, indicating transaction subtotals and totals, etc., providing prompts to the customer and/or to the sales associate); (f) a printer 312 for printing out sales receipts; and (g) a communication controller 314 for allowing the processor 302, and hence, the POS device 102 to engage in communication over data networks with other devices (e.g., a merchant processing system (not shown), and an acquirer (FIG. 1) or its transaction processor (not shown); and the customer profile server computer 114). (In some embodiments, at least one of the displays 310 may be a touch screen, so as to provide an input function as well as an output function. This will particularly likely be the case if the POS device 102 is primarily constituted by a smart phone. In the latter case, the product reader 306 may be constituted by a camera feature of the smart phone.)

In addition, the POS device 102 may include one or more memory and/or data storage devices (indicated collectively at 316), which may comprise any combination of one or more of a hard disk drive, RAM (random access memory), ROM (read only memory), flash memory, etc. The memory/data storage device(s) 316 may store software and/or firmware that programs the processor 302 and the POS device 102 to perform functionality as described herein. Further, the POS device 102 may include one or more housings (not shown) which contain and/or support one or more of the other components shown in FIG. 3.

FIG. 4 is a flow chart that illustrates aspects of the present disclosure, including a portion of the operations of the customer profile server computer 114 (FIGS. 1 and 2).

At 402 in FIG. 4, the customer profile server computer 114 sends an inquiry to a cardholder, to ask the cardholder whether he/she wishes to be eligible for a process in which he/she may register purchased products for warranty purposes in a streamlined manner. The inquiry to the cardholder may occur as part of a batch process. To make the batch process possible, the operator of the payment network 110 (FIG. 1) may have gathered names, PANs and e-mail addresses for cardholders from one or more of the card issuing financial institutions (issuers) that are members of or otherwise participate in the payment network. In some embodiments, the issuers may also already have (at least in some cases) other contact information for the cardholders, including mailing address and telephone number, and possibly demographic information as well. All of this other information may also be gathered by the operator of the payment network. The resulting batch of information about cardholders may then be loaded by the payment network operator into the customer profile server computer 114. In other embodiments, only the cardholders' names, PANs and e-mail addresses may be provided to the customer profile server computer 114. In any case, to implement step 402, the customer profile server computer 114 may send e-mail messages to the cardholders represented by the batch of information. The e-mail message may explain to the cardholder the opportunity he/she has to enable streamlined product warranty registration service, and may ask the cardholder whether he/she wishes to accept the opportunity. For example, the e-mail message may include a virtual button or hyperlink with a label such as “Sign up”, “Enable” or “OK”.

At 404 in FIG. 4, the customer profile server computer 114 determines, for a given cardholder, whether he/she has indicated a desire to enable the streamlined product warranty registration service. Such an indication may be given by the cardholder by “clicking” on the above-described virtual button or hyperlink in the e-mail message sent to him/her by the customer profile server computer 114, and may be referred to as a “positive response.” This may cause a return message or indication to be sent to the customer profile server computer 114 to inform the customer profile server computer 114 that the cardholder wishes to enable the streamlined product warranty registration service. (Those who are skilled in the art will recognize that there are other ways that a cardholder may provide a positive response, such as by accessing a suitable web page maintained by the customer profile server computer 114.)

Upon the customer profile server computer 114 receiving a positive response from the cardholder, step 406 may follow decision block 404. At 406, the customer profile server computer 114 may collect the information that will be required for automated registration of products in the customer's name. For example, the customer profile server computer 114 may send a message to the card issuer to obtain this information, or may prompt the cardholder to enter this information. As will be understood, the information may include the cardholder's name, mailing address, e-mail address, and telephone number, and may be associated with the cardholder's PAN. In some embodiments, the information may include demographic information as well. In some embodiments, the required information may already be available for the customer profile server computer 114 as a result of being loaded into the customer profile server computer 114 in the original batch of cardholder information. In the latter case, the customer profile server computer 114 may collect the product warranty registration information from the batch of cardholder information. In any case, regardless of the manner in which the customer profile server computer 114 collects the required information, it may then (as indicated at 408 in FIG. 4) store the information for the cardholder as a customer profile, which may also be considered a warranty registration record for the cardholder, and which may be associated with the cardholder's PAN. With the customer profile/cardholder warranty registration record in place in the customer profile server computer 114, the customer profile server computer 114 is now able to play its part in the streamlined warranty registration process according to aspects of the present disclosure. There will now follow a description of that process as it may be performed relative to the cardholder whose profile has just been stored in the customer profile server computer 114 pursuant to the process of FIG. 4.

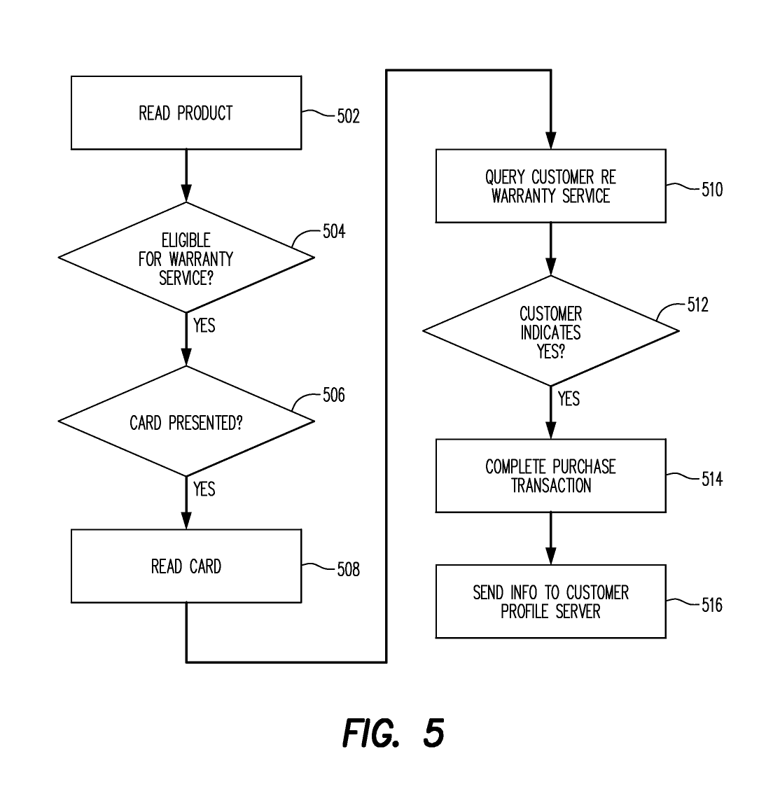

FIG. 5 is a flow chart that illustrates aspects of the present disclosure, including a portion of the operations of the POS device 102 shown in FIGS. 1 and 3.

For purposes of the ensuing discussion of FIG. 5, it will be assumed that the cardholder referred to in connection with FIG. 4, for whom a customer profile has been stored in the customer profile server computer 114, visits a retail store, and selects one or more products for purchase. It will further be assumed that at least one of the products selected by the cardholder (who will now be referred to as the customer) is eligible for a warranty registration via the streamlined process described herein. That is, the latter product (now sometimes to be referred to as the purchased item) is subject to possible warranty registration, and the manufacturer of the product is listed in the database of product manufacturers stored in the customer profile server computer 114 as described above in connection with block 214 in FIG. 2. It will also be assumed that the merchant that operates the POS device 102 also maintains a database of warranty-registration-eligible products; this database may be stored in each POS device 102 operated by the merchant or may be readily accessible to queries from the POS device 102 in a merchant product database server, which is not shown.

In any case, the process of FIG. 5, may be initiated when the customer brings his/her selected purchases to the checkout counter in the store, and the sales associate at the checkout counter presents the purchased item for reading by the product reader 306 (FIG. 3) of the POS device 102. The product reader 306 then reads information (hereinafter at times referred to as “purchased-item information”) from the purchased item, as represented by block 502 in FIG. 5. As will be appreciated from previous discussion, the reading may be by optical barcode reading, or alternatively by RFID reading or by any other reading technology that has been implemented at the POS device 102. The purchased-item information may for example include SKU (stock keeping unit) data that is indicative of the product make and model number and/or type. The purchased-item information may also include the item serial number for the purchased item.

According to an alternative approach, instead of reading the purchased item directly, the POS device 102, via the reader component 106, may read a machine readable card that accompanies the purchased item to provide information about the purchased item that is relevant to warranty registration of the purchased item. (It is a known arrangement for the manufacturer to provide machine readable cards with products for this purpose.)

Following block 502 in FIG. 5 is a decision block 504. At 504, the POS device 102 determines whether the purchased item from which it has just read the purchased-item information is eligible for the streamlined warranty registration process. This may be done by referring to a flag in a database (at the POS device 102 or by query to another device). Assuming in this instance that the purchased item is eligible for the streamlined warranty registration process, then block 506 follows block 504. It may be assumed, as is customary in retail store transactions, that the customer swipes or taps his/her payment card with respect to the reader component 106 of the POS device 102 to consummate the purchase transaction. (Alternatively, of course, the customer may hand his/her card to the sales associate, who may perform the swipe operation.) Thus at 506, the POS device 102 determines whether the customer's payment card has been presented for reading, and if so, the POS device 102 reads the card, as indicated at 508. The reading of the card by the POS device 102 and subsequent authorization of the purchase transaction via the system 100 (FIG. 1) may occur in a conventional manner.

Following 508 in the process of FIG. 5 is block 510. At 510, the POS device 102 may query the customer as to whether the customer wishes to trigger the streamlined warranty registration process for the purchased item. For example, and assuming the POS device 102 includes a customer-facing display screen, the POS device 102 may display a message such as, “Do you want to register your purchase for the manufacturer's warranty program?” At the same time the customer-facing display may display two buttons respectively labeled “Yes” and “No Thanks” Alternatively, the POS device 102 may present a message on the display that faces the sales associate to prompt the sales associate to ask the customer whether he/she wishes to trigger warranty registration. The POS device 102 may be considered to have queried the customer either directly through a display to the customer, or indirectly via the sales associate.

In some embodiments, the step at 510 may follow another step (not shown) in which the POS device 102 or another device refers to a database of customers who have enabled the streamlined warranty registration process to determine whether to engage in step 510. In practice, such a database may simply be a database of PANs of such customers. This may entail, for example, a query message from the POS device 102 to the customer profile server computer 114 and/or to a database maintained at the payment network 110 (FIG. 1) and/or the card issuer 112. If the customer has not enrolled in the streamlined warranty registration system, then step 510 may not take place.

Continuing to refer to FIG. 5, decision block 512 may follow block 510. At decision block 512, the POS device 102 determines whether the customer has provided an indication that he/she wishes to trigger warranty registration for the purchased item. As is implicit in earlier discussion, this may occur directly by the customer actuating a “yes” button on a customer-facing touch screen display or indirectly by the customer orally answering yes to the question from the sales associate and the sales associate inputting the customer's indication into the POS device 102. Both of these manners of providing the customer's positive response to the POS device 102 should be understood as being included in the concept of the POS device 102 receiving the customer's indication that he/she wishes to trigger warranty registration.

Assuming that the POS device 102 receives the positive indication (whether direct or indirect) from the customer, then block 514 follows decision block 512. At 514, the POS device 102 may complete the purchase transaction in a conventional manner, e.g., by recording the sale and by printing out or otherwise providing a transaction receipt to the customer. In some embodiments, however, the POS device 102 may go beyond the conventional process by including on the transaction receipt information to indicate that the streamlined warranty registration process has taken place for the purchased item. In addition, or alternatively, the POS device 102 may display a confirmation that warranty registration is taking place.

Further, block 516 follows (or in some cases may precede or occur in parallel with) block 514. At block 516, the POS device 102 sends a message to the customer profile server computer 114 to indicate that the customer has purchased the purchased item and that warranty registration should take place for the purchased item relative to the customer. In some embodiments, the message from the POS device 102 to the customer profile server computer 114 may include purchased-item information such as the make, model number and serial number for the purchased item, as well as the customer's PAN that corresponds to and was read by the POS device 102 from the card presented by the customer to pay for the purchase transaction. In some embodiments, the message from the POS device 102 to the customer profile server computer 114 may take the form of an API (application program interface) call message to cause the customer profile server computer 114 to retrieve the warranty registration record for the customer. It will be appreciated from earlier discussion that the warranty registration record stored in the customer profile server computer 114 is associated with the customer's PAN, and that the POS device 102 is able to include the PAN in the API call message to the customer profile server computer 114 by having read the PAN at step 508 in FIG. 5.

With the process as described in FIG. 5, all the customer has to do to trigger (and from his/her point of view, complete) the product warranty registration process is to present his/her card to pay for the transaction (which he/she would have to do in any case for a card-based transaction) and to answer “yes” when asked whether he/she desired warranty registration. This is a very minimal amount of effort required for the customer and accordingly may result in a very high frequency of “uptake” and a high level of compliance with the manufacturer's warranty registration program, at least for customers who are profiled in the customer profile server computer 114.

In some embodiments, as an alternative to the customer profile server computer 114 retrieving the customer's contact information from the warranty registration record for the customer, the customer's contact information may be stored on the customer's payment card and may be read from the card by the POS device 102 and then sent from the POS device 102 to the customer profile server computer 114 as part of the message referred to at 516 in FIG. 5.

FIG. 6 is a flow chart that illustrates aspects of the present disclosure, including an additional portion of the operations of the customer profile server computer 114 of FIGS. 1 and 2. More specifically, the process of FIG. 6 may be initiated at the customer profile server computer 114 in response to the message (e.g., API call message) sent at 516 in FIG. 5 by the POS device 102.

At 602 in FIG. 6, the customer profile server computer 114 receives the message sent by the POS device 102. It will be appreciated that the message indicates that the customer has purchased the purchased item and represents a request that a warranty registration be implemented for the purchased item with respect to the customer. It will also be appreciated that the message includes purchased-item information for the purchased item and that the customer profile server computer 114 obtains the purchased-item information by receiving the message.

Following block 602 in FIG. 6 is block 604. At block 604, the customer profile server computer 114 retrieves the warranty registration record for the customer based on the customer's PAN which is included in the message received by the customer profile server computer 114 at block 602.

Block 606 follows block 604 in the process of FIG. 6. At block 606, the customer profile server computer 114 selects a manufacturer (i.e., the manufacturer of the purchased item) based on the purchased-item information included in the message received at 602.

At 608, the customer profile server computer 114 sends the warranty registration to the manufacturer selected at 606. The warranty registration associates the purchased item with the customer, and may include, for example, at least the model and serial number for the purchased item, plus the customer's name and contact information for the customer. In some embodiments, the warranty registration information sent from the customer profile server computer 114 to the manufacturer may include the name and store location for the merchant, and possibly also at least some demographic information about the customer. The date of the purchase transaction may also be included, or may be implied by the date on which step 608 is performed. The purpose of sending the warranty registration to the manufacturer is so that the manufacturer can store the warranty registration as part of the manufacturer's product warranty registration program.

In an alternative embodiment, the customer profile server computer 114 may serve as an out-sourced service provider to the manufacturer and may store the warranty registration on behalf of the manufacturer. For this purpose, the customer profile server computer 114 may store one or more databases for storing product warranty registrations for one or more manufacturers. In some embodiments, the customer profile server computer 114 may receive product warranty registration information from the manufacturer for product purchase transactions that are not triggered via the POS device 102 as described hereinabove. For example, in this embodiment, product warranty registrations that come in to the manufacturer via mail or via the manufacturer's own website may be stored in the customer profile server computer 114 on behalf of the manufacturer in addition to product warranty registrations accomplished via the streamlined/POS process described herein.

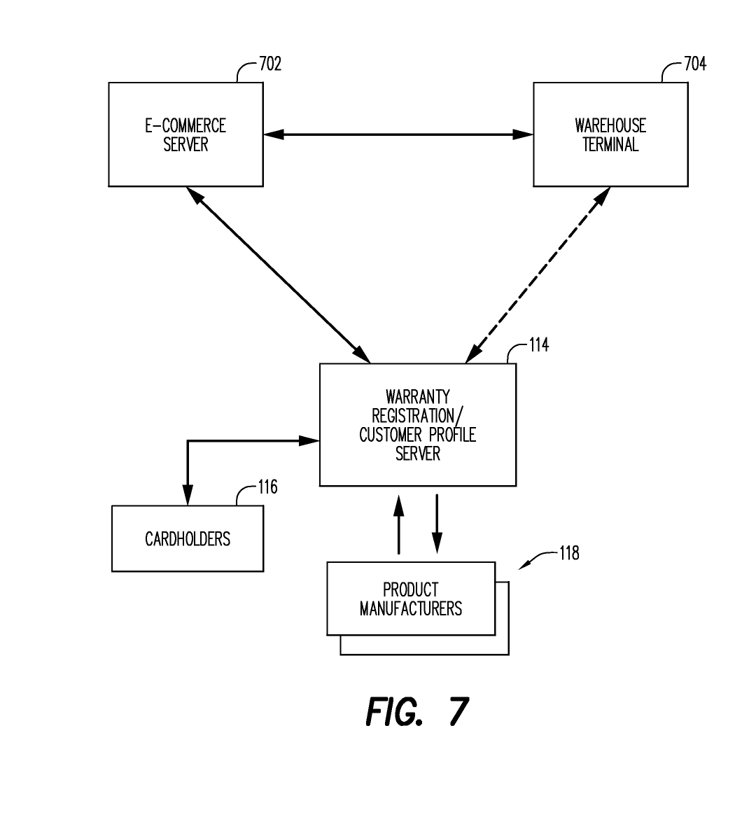

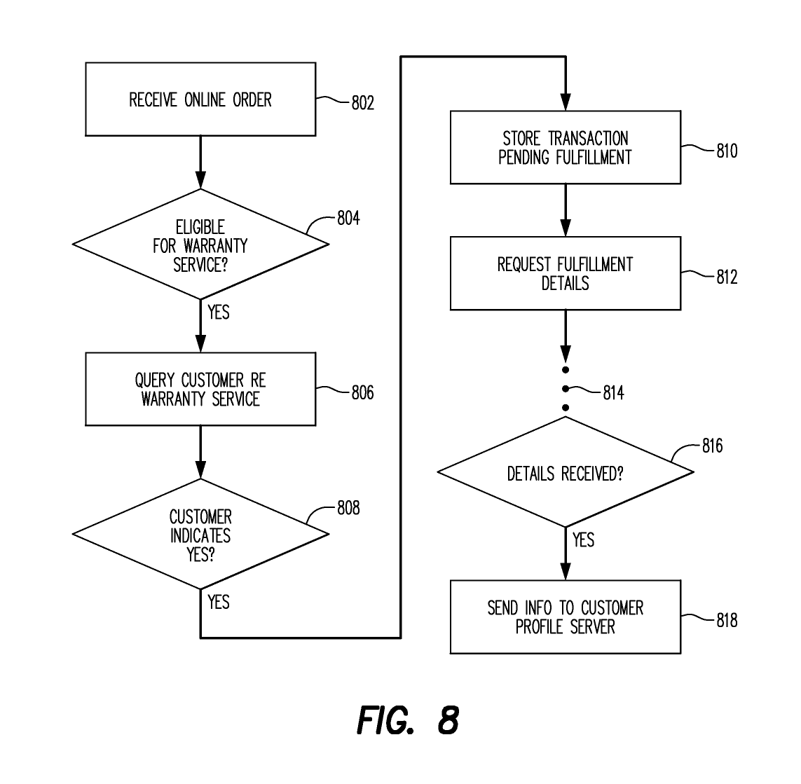

FIG. 7 is a block diagram representation of further features that may be included in the system 100 of FIG. 1 according to some aspects of the disclosure. In particular, FIG. 7 shows additional features that may be incorporated in the system 100 to apply the concept of streamlined, customer-friendly product warranty registration to online purchase transactions. In some embodiments, the processes of FIGS. 5 and 6 may be employed for in-store purchases, while one or more of the processes to be described below in connection with FIGS. 8-11 may be employed for online purchases.

Referring now to FIG. 7, it will be noted that the customer profile server computer 114, the cardholders 116 and the manufacturers 118 represented in FIG. 1 are also depicted in FIG. 7. Also shown in FIG. 7 is an e-commerce server computer 702 via which customer may engage in online purchase transactions from one or more manufacturers. In terms of its hardware aspects, the e-commerce server computer 702 may be entirely conventional; for example, the hardware architecture of the e-commerce server computer 702 may be the same as or similar to the hardware architecture for the customer profile server computer 114 as depicted in FIG. 2. In some embodiments, the e-commerce server computer 702 may be programmed with software and may store data so as to provide functionality in accordance with aspects of the disclosure as described below.

Also shown in FIG. 7 is a warehouse terminal 704, which may be a handheld device of the same general type as used by warehouse employees employed to pick purchased items from the warehouse in order to fulfill online purchase transactions. Although only one warehouse terminal is shown in FIG. 7, it will be appreciated that in many online purchase fulfillment operations a considerable number of such terminals may be deployed and used simultaneously.

The e-commerce server computer 702 is shown as being in communication with the customer profile server computer 114 and the warehouse terminal 704. Also, in some embodiments, the warehouse terminal 704 may be in communication with the customer profile server computer 114.

FIG. 8 is a flow chart that illustrates aspects of the present disclosure, including a portion of operations of the e-commerce server computer 702 shown in FIG. 7.

At 802 in FIG. 8, the e-commerce server computer 702 may receive an online purchase transaction order from a customer. At least in its initial stages, this may occur in a conventional manner, such as by the customer accessing the online store website maintained by the e-commerce server computer 702, selecting an item for purchase, placing the selected item in the online “shopping cart”, and indicating that the customer is ready to “check out” (i.e., to complete the purchase).

Following block 802 in FIG. 8 is a decision block 804. At 804, the e-commerce server computer 702 determines whether the purchased item ordered (or about to be ordered) by the online customer is eligible for the streamlined warranty registration process. This may be done, for example, by referring to a flag in a product database maintained in the e-commerce server computer 702, or may be determined by a query sent from the e-commerce server computer 702 to another device. Assuming in this instance that the purchased item is eligible for the streamlined warranty registration process, then block 806 follows block 804. At 806, the e-commerce server computer 702 may query the customer as to whether the customer wishes to trigger the streamlined warranty registration process for the purchased item. For example, the e-commerce server computer 702 may download a page to the customer's computer to display a message such as, “Do you want to register your [name of product] for the manufacturer's warranty program?” At the same time the page may display two buttons respectively labeled “Yes” and “No Thanks”.

In some embodiments, the step at 806 may follow another step (not shown) in which the e-commerce server computer 702 refers to a database of customers who have enabled the streamlined warranty registration process to determine whether to engage in step 806. In practice, such a database may simply be a database of PANs of such customers. In some embodiments, for example, the e-commerce server computer 702 may send a query message to the customer profile server computer 114 and/or to a database maintained at the payment network 110 (FIG. 1) and/or the card issuer 112 to inquire as to whether the customer has signed up for streamlined warranty registration service.

Continuing to refer to FIG. 8, decision block 808 may follow block 806. At decision block 808, the e-commerce server computer 702 determines whether the customer has provided an indication that he/she wishes to trigger warranty registration for the purchased item. This may occur by the customer clicking on the “Yes” button on the page that was downloaded to his/her computer at 806.

Assuming that the e-commerce server computer 702 receives the positive indication from the customer, then block 810 follows decision block 808. At 810, the e-commerce server computer 702 may store the transaction in a pending transaction database to await receipt of the fulfillment information for the order. At the same time, the e-commerce server computer 702 may complete the charging of the transaction to the customer's payment card account, and may indicate to the customer that the order is complete. As part of the latter, in some embodiments, the e-commerce server computer 702 may indicate to the customer that the streamlined warranty registration process will occur for the purchased item.

Block 812 follows block 810. At block 812, the e-commerce server computer 702 places a request to receive details concerning the fulfillment of the order, such as the serial number for the stock unit picked from the warehouse to fulfill the order. Then (possibly after a pause or delay indicated at 814), a decision block 816 may follow. At decision block 816, the e-commerce server computer 702 may determine whether it has received the fulfillment details for the order. If so, then block 818 follows.

At block 818, the e-commerce server computer 702 sends a message to the customer profile server computer 114 to indicate that the customer has purchased the purchased item and that warranty registration should take place for the purchased item relative to the customer. In some embodiments, the message from the e-commerce server computer 702 to the customer profile server computer 114 may include purchased item information such as the make, model number and serial number for the purchased item, as well as the customer's PAN that corresponds to the payment card account information entered by the customer to pay for the online purchase transaction. In some embodiments, the message from the e-commerce server computer 702 to the customer profile server computer 114 may take the form of an API (application program interface) call message to cause the customer profile server computer 114 to retrieve the warranty registration record for the customer. It will be appreciated from earlier discussion that the warranty registration record stored in the customer profile server computer 114 is associated with the customer's PAN. From the point of view of the customer profile server computer 114, the message/API call from the e-commerce server computer 702 may be equivalent to or indistinguishable from the message from the POS device 102 as described above with reference to block 516 in FIG. 5. Thus, and again from the point of view of the customer profile server computer 114, the e-commerce server computer 702 may be considered to be a point-of-sale device. Like the message referred to in block 516, the message referred to in block 818 may cause the customer profile server computer 114 to engage in the process described above in connection with FIG. 6.

As with the process described in FIG. 5, the process of FIG. 8 makes it very simple and convenient for the customer to trigger the product warranty registration process. Essentially all that is required from the customer is one more click in the online purchase transaction process. Again, it can be expected that this may result in a very high frequency of uptake and a high level of compliance with the manufacturer's warranty registration program.

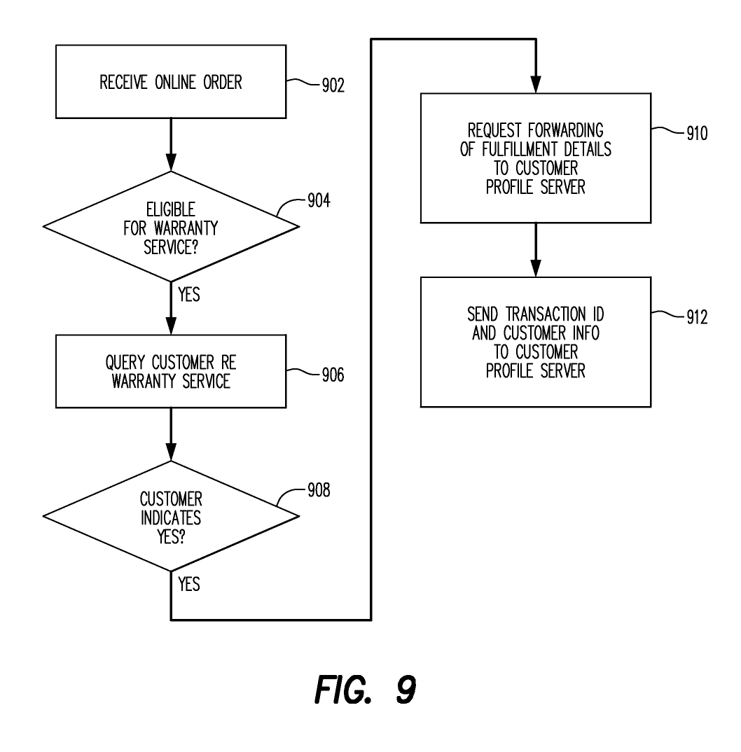

FIG. 9 is a flow chart that illustrates an alternative manner of operation for the e-commerce server computer 702 according to aspects of the disclosure.

In FIG. 9, steps 902, 904, 906 and 908 may be the same as, or substantially similar to, the steps 802, 804, 806 and 808 illustrated in FIG. 8 and described above. Accordingly, steps 902-908 will not be described, but rather, the reader will be referred back to the above description of steps 802-808. Referring to FIG. 9, assuming that e-commerce server computer 702 receives the positive indication from the customer at decision block 908, then block 910 follows decision block 908. At block 910, the e-commerce server computer 702 requests that the order fulfillment information, when available, be forwarded to the customer profile server computer 114. This may also include forwarding the information required to fulfill the order, such as the identifiers and/or names/descriptions of the items ordered for this transaction. At the same time, the e-commerce server computer 702 may complete the charging of the transaction to the customer's payment card account, and may indicate to the customer that the order is complete. As part of the latter, in some embodiments, e-commerce server computer 702 may indicate to the customer that the streamlined warranty registration process will occur for the purchased item.

Continuing to refer to FIG. 9, block 912 follows block 910. At block 912, the e-commerce server computer 702 sends a message to the customer profile server computer 114. The message may include a transaction identification number, plus the customer's PAN.

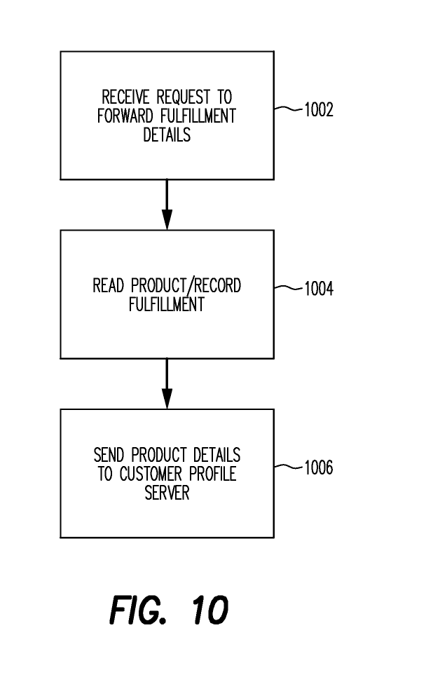

FIG. 10 is a flow chart that illustrates a portion of the operations of the warehouse terminal 704 shown in FIG. 7.

At block 1002 in FIG. 10, the warehouse terminal 704 receives from the e-commerce server computer 702 the request referred to above in connection with block 910 in FIG. 9. That is, the warehouse terminal 704 receives the request to forward the order fulfillment information to the customer profile server computer 114. Then, at block 1004 in FIG. 10, the warehouse terminal 704 reads information from the stock unit that is picked to fulfill the order. This may be done, for example, by barcode and/or RFID reading. The information read may include the serial number for the stock unit, and may also confirm that the make and model number for the stock unit match the purchased item specified in the order.

Next, at 1006, the warehouse terminal 704 sends the order fulfillment information (or at least information such as the item serial number necessary to identify the particular unit used to fulfill the order) to the customer profile server computer 114. The message sent from the warehouse terminal 704 to the customer profile server computer 114 may also include the transaction identification number referred to above in connection with block 912 in FIG. 9 to allow the customer profile server computer 114 to match the purchased item information with the customer PAN sent to it by the e-commerce server computer 702 at 912.

FIG. 11 is a flow chart that illustrates a process that may be performed by the customer profile server computer 114 in accordance with other aspects of the disclosure, and in response to the processes described above in connection with FIGS. 9 and 10.

At block 1102 in FIG. 11, the customer profile server computer 114 receives the information sent to it by the e-commerce server computer 702 at block 912 in FIG. 9. That is, the customer profile server computer 114 receives a transaction identification number and the customer's PAN. (In some embodiments, the make and/or the model of the purchased item may also be included in the information received by the customer profile server computer 114 at this stage from the e-commerce server computer 702.) Then (possibly after a pause or delay indicated at 1104 in FIG. 11), a decision block 1106 follows. At decision block 1106, the customer profile server computer 114 determines whether it has received the product information (i.e., the relevant portion of the order fulfillment information) that relates to the particular transaction, as described in step 1006 of FIG. 10. Once this occurs (i.e., once step 1006 of FIG. 10 is accomplished), then blocks 1108 and 1110 of FIG. 10 follow. At block 1108, the customer profile server computer 114 selects a manufacturer (i.e., the manufacturer of the purchased item) based on the information received at 1106 from the warehouse terminal 704. Alternatively, the make of the purchased item may have been contained in the message sent to the customer profile server computer 114 from the e-commerce server computer 702 at block 912 in FIG. 9.

Block 1110 in FIG. 11 may be the same as or substantially similar to block 608 described above in relation to FIG. 6, and so will not be separately described except by referring back to the description of block 608.

With the processes as described above in connection with FIGS. 7-11, the e-commerce portion of a manufacturer's sales may also be served with a product warranty registration process that is essentially as seamless and convenient for the customer as the in-store process described in connection with FIGS. 5 and 6.

In descriptions set forth above, e.g., in connection with FIG. 4, it was indicated that the customer profile server computer 114 interacted with and/or sent queries to cardholders to enroll them in the streamlined warranty registration system. In addition or alternatively, a different computer system, such as one operated by the relevant payment card account issuer 112, or a different computer operated by the payment network operator 110, may perform the querying of, and/or interaction with, prospective enrollees and may download the resulting customer profiles to the customer profile server computer 114.

As used herein and in the appended claims, “purchased item” includes an item presented for purchase at a point-of-sale terminal or device.

As used herein and in the appended claims, “customer profile server” refers to any computer or other device that receives requests from POS devices and/or e-commerce servers to initiate storage of a product warranty registration.

As used herein and in the appended claims, a “streamlined” warranty registration process is one which, for a given purchase transaction, requires no more from the customer than a single indication of consent to warranty registration, beyond customary steps by the customer to consummate a purchase transaction.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous of requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
reading purchased-item information by a point-of-sale (POS) device from a purchased item presented to the POS device;
determining by the POS device that the purchased item is eligible for warranty registration;
reading a payment card by the POS device;
querying a customer by the POS device as to whether the customer wishes to trigger warranty registration for the purchased item;
receiving by the POS device an indication from the customer to trigger warranty registration for the purchased item; and
sending by the POS device a message to a customer profile server to trigger warranty registration of the purchased item.

2. The method of claim 1, wherein the purchased-item information read by the POS device includes information indicative of a model number and a serial number for the purchased item.

3. The method of claim 2, wherein;
the step of reading the payment card includes reading by the POS device a primary account number (PAN) associated with a payment card account owned by the customer; and
the message sent by the POS device to the customer profile server includes the PAN read from the payment card and the model and serial numbers for the purchased item.

4. The method of claim 3, wherein the message sent by the POS device to the customer profile server includes an API call to cause the customer profile server to retrieve a warranty registration record associated with the PAN read from the payment card.

5. The method of claim 4, wherein the warranty registration record associated with the PAN includes the customer's name and contact information for the customer.

6. The method of claim 1, wherein the step of reading the payment card includes reading the customer's name and contact information for the customer from the payment card.

7. The method of claim 6, wherein:
the purchased-item information read by the POS device includes information indicative of a model number and a serial number for the purchased item; and
the message sent by the POS device to the customer profile server includes the customer's name and contact information for the customer and the model and serial numbers for the purchased item.

8. A point-of-sale (POS) device comprising:
a processor;
a card reading unit in communication with the processor for reading information from a payment card;
a purchased-item reading unit in communication with the processor for reading purchased-item information from a purchased item presented to the POS device; and
a memory in communication with the processor;
wherein the processor is programmed to:
determine that the purchased item is eligible for warranty registration;
query a customer as to whether the customer wishes to trigger warranty registration for the purchased item;
receive an indication from the customer to trigger warranty registration for the purchased item; and
send a message to a customer profile server to trigger warranty registration of the purchased item.

9. The POS device of claim 8, wherein the purchased-item information read from the purchased item includes information indicative of a model number and a serial number for the purchased item.

10. The POS device of claim 9, wherein:
the information read from the payment card includes a primary account number (PAN) stored on the payment card and associated with a payment card account owned by the customer; and
the message sent to the customer profile server includes the PAN read from the payment card and the model and serial numbers for the purchased item.

11. The POS device of claim 10, wherein the message sent to the customer profile server includes an API call to cause the customer profile server to retrieve a warranty registration record associated with the PAN read from the payment card.

12. The POS device of claim 8, wherein the purchased-item reading unit includes at least one of an optical barcode reader and an RFID (radio frequency identification) reader.

13. The POS device of claim 8, wherein the card reading unit reads the customer's name and contact information for the customer from the payment card.

14. The POS device of claim 13, wherein:
the purchased-item information read by the purchased-item reading unit includes information indicative of a model number and a serial number for the purchased item; and
the message sent to the customer profile server includes the customer's name and contact information for the customer and the model and serial numbers for the purchased item.

15. A method comprising:
sending a first message to a cardholder to inquire as to whether the cardholder wishes to enable streamlined warranty registration service;
receiving a positive response from the cardholder;
responding to the positive response by storing in a customer profile server a warranty registration record for the cardholder, the warranty registration record including the cardholder's name and contact information for the cardholder and being associated with a primary account number (PAN) that identifies a payment card account owned by the cardholder;
receiving a second message from a point-of-sale (POS) device, the second message indicating that the cardholder has purchased a purchased item;
obtaining purchased-item information for the purchased item, the purchased-item information including a model number for the purchased item and a serial number for the purchased item; and
responding to the second message by storing a warranty registration for the purchased item.

16. The method of claim 15, wherein the step of storing the warranty registration for the purchased item includes:
selecting a product manufacturer based on the purchased-item information; and
sending to the selected product manufacturer the cardholder's name and contact information and the model number for the purchased item and the serial number for the purchased item.

17. The method of claim 16, wherein:
the second message includes merchant information that identifies a merchant from which the cardholder purchased the purchased item; and
the step of storing the warranty registration for the purchased item includes sending the merchant information to the product manufacturer for storage by the product manufacturer.

18. The method of claim 15, wherein the obtaining step includes receiving the purchased-item information as part of the second message.

19. The method of claim 15, wherein the obtaining step includes receiving the purchased-item information as part of a third message received from a warehouse terminal device operated by an e-commerce merchant.

20. The method of claim 15, wherein:
the second message includes the cardholder's PAN, and the method further comprises:
retrieving the warranty registration record based on the cardholder's PAN included in the second message.
